(19) United States
(12) Patent Application Publication
(10) Pub. No.: US 2026/0113165 A1
(43) Pub. Date: Apr. 23, 2026

(54) MULTI-LINK DEVICE AND METHOD FOR SUPPORTING BLOCK ACKNOWLEDGEMENT MECHANISM

(71) Applicant: TP-Link Systems Inc., IRVINE, CA (US)

(72) Inventors: Shuyu SHI, Shanghai (CN); Junbin CHEN, Chengdu (CN); Xuefeng NIU, Shenzhen (CN); Da SUN, Shenzhen (CN)

(73) Assignee: TP-Link Systems Inc., IRVINE, CA (US)

(21) Appl. No.: 18/921,792

(22) Filed: Oct. 21, 2024

(51) Int. Cl. H04L 5/00; H04W 76/15

(52) U.S. Cl. CPC H04L 5/0055; H04W 76/15

(57) ABSTRACT

A recipient Multi-Link Device (MLD) including one or more processors; a memory coupled to at least one of the processors; and a set of computer program instructions stored in the memory, which, when executed by at least one of the processors, perform actions of: receiving, from an originator MLD, an indication for indicating a MLD Block Acknowledgment (BA) scheme; and delivering, in response to the HOL support indication indicating a diversity MLD BA scheme of transmitting duplicated sets of data frames on multiple links established between the recipient and originator MLDs, received data frames of a plurality of data frames from a first layer to a second layer of the recipient MLD according to the diversity MLD BA scheme, wherein the second layer is higher than the first layer.

### TECHNICAL FIELD

The present disclosure relates to wireless communication, and in particular, to Multi-Link Devices (MLDs), methods, system and computer program products for supporting block acknowledgement (BA) mechanism.

### BACKGROUND

In the context of Wi-Fi communication, an acknowledgement (ACK) procedure has been proposed to ensure the integrity and reliability of data transmission. Upon successful reception of a data frame from an originator device, a recipient device sends an ACK frame back to the originator device for acknowledging the data frame received. Otherwise, a negative acknowledgment (NACK) will be transmitted, which allows for retransmission.

Block acknowledgement (BA) mechanism was introduced in the 802.11e amendment to improve efficiency by allowing for the transfer of a block of data frames that are acknowledged with a single BA frame instead of an ACK frame for each of the individual data frames. However, there is still a need for enhancements on the BA mechanism.

### SUMMARY

In view of the above problems, the present disclosure provides recipient and originator MLDs, methods, system, and computer program products for supporting block acknowledgement (BA) mechanism.

In accordance with one embodiment of the present disclosure, there is provided a recipient Multi-Link Device (MLD). The recipient MLD may comprise one or more processors; a memory coupled to at least one of the processors; and a set of computer program instructions stored in the memory. When executed by at least one of the processors, the set of computer program instructions may perform the following actions: receiving, from an originator MLD, an indication for indicating a MLD Block Acknowledgment (BA) scheme; and delivering, in response to the indication indicating a diversity MLD BA scheme of transmitting duplicated sets of data frames on multiple links established between the recipient MLD and the originator MLD, received data frames of a plurality of data frames from a first layer to a second layer of the recipient MLD according to a delivery scheme corresponding to the diversity MLD BA scheme, wherein the second layer is higher than the first layer.

In accordance with another embodiment of the present disclosure, there is provided an originator Multi-Link Device (MLD). The originator MLD may comprise one or more processors; a memory coupled to at least one of the processors; and a set of computer program instructions stored in the memory. When executed by at least one of the processors, the set of computer program instructions may perform the following actions: transmitting, to a recipient MLD, an indication for indicating a MLD Block Acknowledgment (BA) scheme; and transmitting, to the recipient MLD in response to the HOL support indication indicating a diversity MLD BA scheme of transmitting duplicated sets of data frames on multiple links established between the recipient MLD and the originator MLD, a plurality of data frames on the established multiple links according to the diversity MLD BA scheme.

In accordance with a further embodiment of the present disclosure, there is provided a method for wireless communication implemented at a recipient Multi-Link Device (MLD). The method may comprise receiving, from an originator MLD, an indication for indicating a MLD Block Acknowledgment (BA) scheme; and delivering, in response to the indication indicating a diversity MLD BA scheme of transmitting duplicated sets of data frames on multiple links established between the recipient MLD and the originator MLD, received data frames of a plurality of data frames from a first layer to a second layer of the recipient MLD according to a delivery scheme corresponding to the diversity MLD BA scheme, wherein the second layer is higher than the first layer.

In accordance with yet another embodiment of the present disclosure, there is provided a method for wireless communication implemented at an originator Multi-Link Device (MLD). The method may comprise transmitting, to a recipient MLD, an indication for indicating a MLD Block Acknowledgment (BA) scheme; and transmitting, to the recipient MLD in response to the indication indicating a diversity MLD BA scheme of transmitting duplicated sets of data frames on multiple links established between the recipient MLD and the originator MLD, a plurality of data frames on the established multiple links according to the diversity MLD BA scheme.

In accordance with still another embodiment of the present disclosure, there is provided a computer program product for wireless communication. The computer program product may comprise a non-transitory computer readable storage medium having program instructions embodied therewith. The program instructions are executable by a processor of a recipient Multi-Link Device (MLD) to cause the processor to receive, from an originator MLD, an indication for indicating a MLD Block Acknowledgment (BA) scheme; and deliver, in response to the indication indicating a diversity MLD BA scheme of transmitting duplicated sets of data frames on multiple links established between the recipient MLD and the originator MLD, received data frames of a plurality of data frames from a first layer to a second layer of the recipient MLD according to a delivery scheme corresponding to the diversity MLD BA scheme, wherein the second layer is higher than the first layer.

In accordance with a yet further embodiment of the present disclosure, there is provided a computer program product for wireless communication. The computer program product may comprise a non-transitory computer readable storage medium having program instructions embodied therewith. The program instructions are executable by a processor of an originator Multi-Link Device (MLD) to cause the processor to transmit, to a recipient MLD, an indication for indicating a MLD Block Acknowledgment (BA) scheme; and transmit, to the recipient MLD in response to the indication indicating a diversity MLD BA scheme of transmitting duplicated sets of data frames on multiple links established between the recipient MLD and the originator MLD, a plurality of data frames on the established multiple links according to the diversity MLD BA scheme.

In accordance with another embodiment of the present disclosure, there is provided a wireless communication system comprising at least an originator Multi-Link Device (MLD) and a recipient MLD. The originator MLD may be configured to perform actions of: transmitting, to a recipient MLD, an indication for indicating a MLD Block Acknowledgment (BA) scheme; and transmitting, to the recipient MLD in response to the indication indicating a diversity MLD BA scheme of transmitting duplicated sets of data frames on multiple links established between the recipient MLD and the originator MLD, a plurality of data frames on the established multiple links according to the diversity MLD BA scheme. Accordingly, the recipient MLD may be configured to perform actions of: receiving, from the originator MLD, the indication; and delivering, in response to the indication indicating the diversity MLD BA scheme of transmitting duplicated sets of data frames on the established multiple links, received data frames of the plurality of data frames from a first layer to a second layer of the recipient MLD according to a delivery scheme corresponding to the diversity MLD BA scheme, wherein the second layer is higher than the first layer.

In accordance with the embodiments of the present disclosure, an enhanced BA mechanism for data transmissions between wireless communication devices can be realized utilizing Multi-Link Operation (MLO).

### BRIEF DESCRIPTION OF THE DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps, or elements.

FIG. 1 illustrates an exemplary network topology 100 for data transmission between wireless communication devices in accordance with an embodiment of the present disclosure;

FIG. 2 shows an exemplary schematic diagram illustrating the message sequence 200 for interactions between wireless communication devices in the Immediate BA mechanism;

FIG. 3 shows an exemplary schematic diagram illustrating the message sequence 300 for interactions between wireless communication devices in the Delayed BA mechanism;

FIG. 4 shows an exemplary schematic diagram illustrating an A-MPDU used in the HT BA mechanism;

FIG. 5 shows an exemplary schematic diagram illustrating a head-of-line (HOL) blocking issue in the existing Immediate BA mechanism;

FIG. 6 illustrates an exemplary ML arrangement 600 in accordance with an embodiment of the present disclosure;

FIG. 7 illustrates an exemplary multi-link reference model 700 for a ML device in accordance with an embodiment of the present disclosure;

FIG. 8 shows an exemplary schematic diagram illustrating an enhanced MLD BA mechanism in accordance with an embodiment of the present disclosure;

FIG. 9 shows an exemplary schematic diagram illustrating a BA bitmap 900 in the enhanced MLD BA mechanism in accordance with an embodiment of the present disclosure;

FIG. 10 shows an exemplary schematic diagram illustrating another enhanced MLD BA mechanism in accordance with an embodiment of the present disclosure;

FIG. 11 shows an exemplary schematic diagram illustrating a Packet Number (PN) window bitmap 1100 in the enhanced MLD BA mechanism in accordance with an embodiment of the present disclosure;

FIG. 12 shows a flowchart of a computer-implemented method 1200 for wireless communication implemented at a recipient MLD in accordance with an embodiment of the present disclosure;

FIG. 13 shows a flowchart of a computer-implemented method 1300 for wireless communication implemented at an originator MLD in accordance with an embodiment of the present disclosure; and

FIG. 14 is an exemplary block diagram illustrating a computing device in accordance with some embodiments of the present disclosure.

One skilled in the art will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

The following detailed description refers to the accompanying drawings. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “receiving”, “delivering”, “transmitting”, “sending”, “discarding”, “maintaining”, “reordering”, “switching”, “establishing”, “enabling”, “accepting”, “rejecting” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner. Likewise, articles such as “a”, “an” or “the” do not represent a quantity limit, but represent an existence of at least one. Words such as “connect” and “link” are not limited to physical or mechanical connections, but may include electrical connections, whether direct or indirect.

In addition, technical features involved in different embodiments of the present disclosure described below may be combined with each other as long as no conflicts occurs therebetween.

In the present disclosure, an AP, which may be interchangeably referred to as a wireless access point (WAP), is a communication device that can communicate with a non-AP device (e.g., a station (STA) or client device) in a WLAN and that allows the non-AP to connect to a wired network. The AP usually connects to a router (via a wired network) as a standalone device, but it can also be integrated with or employed in the router. Likewise, in the present disclosure, a non-AP (e.g., a client device or station, which is interchangeably referred to as a STA) is a communication device that can communicate with an AP to obtain various communication services such as voice, video, packet data, messaging, broadcast, etc. The STA can be any device that contains an IEEE 820.11-conformant media access control (MAC) and physical layer (PHY) interface to the wireless medium (WM). For example, a STA may be a laptop, a desktop personal computer (PC), a personal digital assistant (PDA), an access point or a Wi-Fi phone in a WLAN environment. The STA may be fixed or mobile. In the WLAN environment, the terms “STA”, “client device”, “wireless client”, “user” and “user device” are often used interchangeably.

In the present disclosure, a STA in a WLAN may work as an AP at a different occasion, and vice versa. This is because communication devices in the context of IEEE 820.11 (Wi-Fi) technologies may include both STA hardware components and AP hardware components. In this manner, the communication devices may switch between a STA mode and an AP mode, based on actual WLAN conditions and/or requirements. In various embodiments below, a non-AP STA may refer to a STA in a WLAN that is not implemented as an AP.

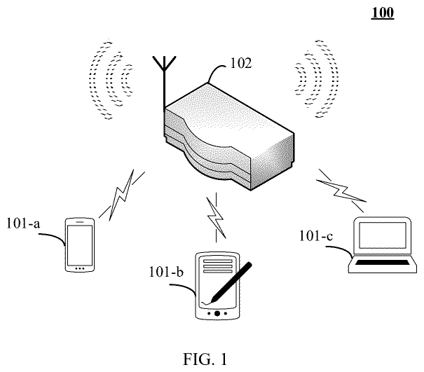

FIG. 1 illustrates an exemplary network topology 100 for data transmission between wireless communication devices according to an embodiment of the present disclosure.

As shown in FIG. 1, the exemplary network topology 100 is depicted, which includes three client devices 101-a, 101-b, and 101-c (collectively referred to as a client device 101) connected to an access point (AP) 102, and can be employed in 802.11 WLAN networks. Examples of the client devices 101 may include, for example, smartphones, tablets, computers, and other internet-capable devices. As previously discussed, the AP 102 is capable of establishing WLAN communication with the client devices 101, enabling the client devices to connect to a wired network. This permits the client devices to access a variety of communication services from the Internet, including voice, video, packet data, messaging, and broadcast, among others. After the client devices 101 successfully associates with the AP 102 through the 802.11 association procedure, data transfer between the client devices 101 and the AP 102 can commence. This allows the client devices 101 to transmit and receive data packets to and from the network through the AP 102.

The architecture presented in FIG. 1 is only illustrative and does not impose any limitations on any embodiment of the present disclosure. Multiple APs in the WLAN network can serve specific sets of associated client devices, and depending on application requirements and overall network constraints, the number of client devices in each serving set can be greater or less than the three client devices as depicted.

As mentioned above, BA mechanism is proposed in 802.11 Standards to facilitate data communications in WLAN networks. Two approaches of BA were originally defined in the 802.11e Amendment: Immediate BA and Delayed BA. Furthermore, both BA approaches are enhanced in the 802.11n Amendment to improve efficiency and take advantage of aggregation and the higher data rates, and the enhanced mechanisms of BA are referred to as high-throughput (HT)-immediate BA and HT-delayed BA. However, the existing BA mechanisms still require further improvements, as described hereinafter.

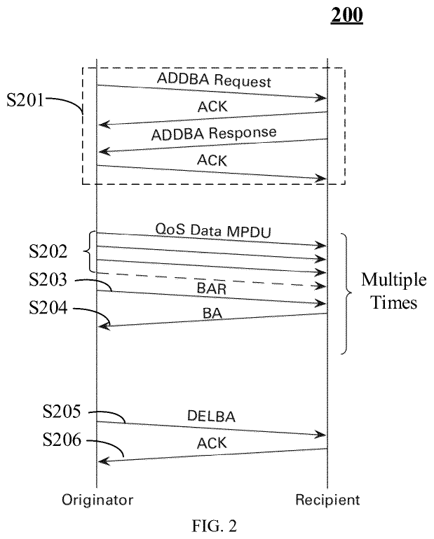

FIG. 2 shows an exemplary schematic diagram illustrating the message sequence 200 for interactions between wireless communication devices in the Immediate BA mechanism.

As shown in FIG. 2, the wireless communication device with data frames to send is referred to as originator, transmitter, or transmitting device, while another wireless communication device serving as the receiver of the data frames is referred to as recipient, receiver, or receiving device. For example, in conjunction with the topology 100 shown in FIG. 1, when there is a downlink data transmission from the AP 102 to the client device 101, the AP 102 is the originator and the client device 101 is the recipient; conversely, when there is an uplink data transmission from the client device 101 to the AP 102, the client device 101 is the originator and the AP 102 is the recipient. During data communication between the two wireless communication devices, the Immediate BA mechanism can be implemented, which is described hereinafter in combination with the message sequence 200 of FIG. 2.

At a first stage for BA session initiation (i.e., setup stage), as shown in step S201 of FIG. 2, the BA mechanism needs to be enabled by establishing a BA session through exchange of ADDBA Request and Response, as well as their responding ACKs. The BA session is established between two wireless communication devices for a particular traffic identifier (TID) and for data transfer in one direction, i.e., from originator to recipient.

At a second stage for BA session data transfer (i.e., data and acknowledgment transfer stage), as shown in steps S202-S204 of FIG. 2, the data transfer is started subsequence to a successful ADDBA exchange. The originator will send a block of data (e.g., Quality of Service (QoS) Data MPDUs) in step S202 followed by a BAR in step S203, to which the recipient will respond with a BA in step S204. The BA in step S204 acknowledges correctly received data frames from the previous block of data frames sent in step S202. The originator requeues data frames which were not correctly received and may re-transmit them in the subsequent block (not shown). In addition, the above steps S202-S204 may be performed many times if there is continuous data transmission from the originator to the recipient.

At a third stage for BA session tear down (i.e., tear down stage), as shown in steps S205-S206 of FIG. 2, the originator or recipient may tear down the BA session by sending a DELBA Request in step S205 which, if correctly received, is acknowledged with an ACK in step S206 as a response.

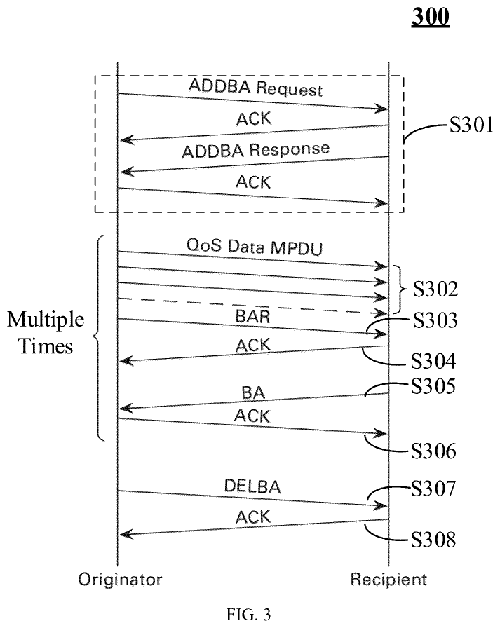

FIG. 3 shows an exemplary schematic diagram illustrating the message sequence 300 for interactions between wireless communication devices in the Delayed BA mechanism.

It should be noted that, the overall data frame exchange procedure 300 of Delayed BA mechanism of FIG. 3 is substantially the same as the Immediate BA mechanism of FIG. 2, both including a setup stage (including step S301 of FIG. 3), a data transfer stage (including steps S302-S306 of FIG. 3), and a tear down stage (including steps S307-S308 of FIG. 3). Immediate BA of FIG. 2 and delayed BA of FIG. 3 differ in handling of the BAR and BA frames during the data transfer phase. With immediate BA, the BAR solicits an immediate BA response, while with delayed BA, correct reception of the BAR frame itself (in step S303) is acknowledged with an ACK (in step S304) and the BA is returned in a separate channel access (in step S305) and acknowledged with another ACK (in step S306), details for the same operations of the frame interactions are omitted here.

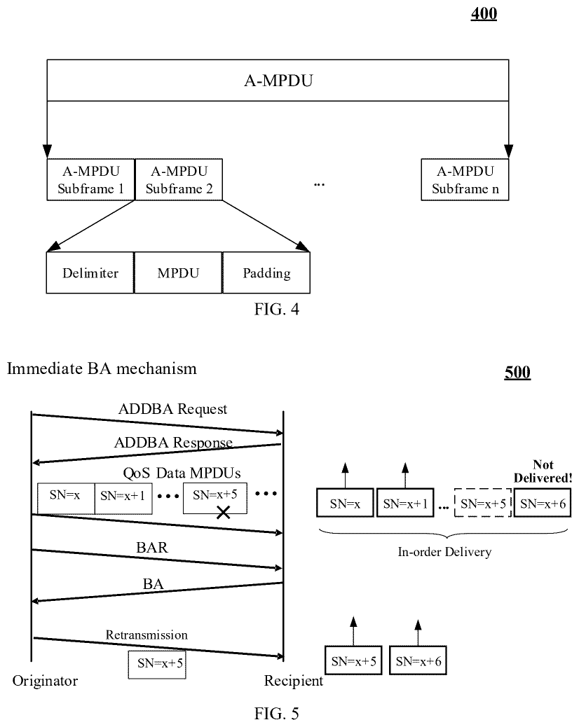

FIG. 4 shows an exemplary schematic diagram illustrating an A-MPDU used in the HT BA mechanism.

As mentioned above, the HT-immediate and HT-delayed BA mechanisms improve efficiency and take advantage of aggregation and the higher data rates than the immediate and delayed BA mechanisms illustrated in FIGS. 2-3. The HT-immediate and HT-delayed BA mechanisms differ from the immediate and delayed BA mechanisms in that they do not transmit multiple QoS data MPDUs; instead, in the HT-immediate and HT-delayed BA mechanisms, the originator (for example, the originator in FIGS. 2-3) encapsulates multiple MPDUs into an Aggregate MPDU (A-MPDU) and transmits it within a single TXOP.

As shown in the A-MPDU encapsulation 400 of FIG. 4, with the format of A-MPDU, multiple MPDUs (also referred to as A-MPDU subframes 1-n) are aggregated. Each A-MPDU subframe consists of an MPDU Delimiter and the MPDU entity. For an A-MPDU, except for the last subframe, the other subframes will have a padding field of 0-3 bytes to make the subframe length a multiple of 4 bytes. The recipient of the A-MPDU parses the A-MPDU framing structure by using each delimiter to extract the following MPDU.

Furthermore, unlike the immediate and delayed BA mechanisms where the originator actively sends a BAR after the transmission of QoS data MPDUs, and then the recipient returns a BA message, the HT-immediate and HT-delayed BA mechanisms operate such that after the recipient finishes receiving of the A-MPDU within a TXOP, the originator does not send a BAR, but the recipient directly returns the BA message.

FIG. 5 shows an exemplary schematic diagram illustrating a head-of-line (HOL) blocking issue in the existing Immediate BA mechanism.

For the existing Immediate BA mechanism, for example, during the BA session data transfer stage, MSDUs (e.g., those decoded and decapsulated from the received MPDUs) received at the MAC layer are transferred to an upper layer using in-order delivery scheme, which means that once an MPDU is received, two following operations are required at the recipient.

The first operation is to record that the MPDU is received successfully in a scoreboard, which maintains a record to track which MPDUs have been received correctly and may also be referred to as a BA bitmap.

The second operation is to buffer the MPDU in a reorder buffer. Specifically, based on whether there is an incomplete preceding MSDU forming a hole, the recipient will determine whether to deliver the MPDU to an upper layer, such as LLC layer, or store the MPDU in the reorder buffer. If there is no incomplete preceding MSDU, the MPDU will be decapsulated to MSDU and then delivered to higher layers. If there is, however, an incomplete preceding MSDU forming a hole, the MPDU will be stored in the reorder buffer at the MAC layer without transferring to the LLC layer.

In order to provide feedback on whether the data frames are correctly received or not, the recipient may leverage the BA bitmap in the BA frame (such as in step S204 of FIG. 2) to record whether the MPDUs are received during the established BA session. According to such feedback approach, the received MPDUs, even with an incomplete preceding MSDU(s) forming hole(s), will be fed back to the originator with a result that they are received successfully and therefore no retransmission is required for these received MPDUs. These MPDUs will, however, not be delivered to the LLC layer due to the in-order delivery restriction of the current Wi-Fi MAC requirements, since there is a preceding “hole”. This is referred to as the head-of-line (HOL) blocking issue in the existing BA mechanism. The HOL blocking issue will be described in combination with the message sequence 500 of FIG. 5.

As shown in FIG. 5, the BA session may be established between the originator and the recipient through the exchange of ADDBA request and response frames. After that, the originator may start transmitting a block of data frames (such as QoS Data MPDUs), which is labeled as the data frame with sequence numbers (SNs) of SN=x, SN=x+1, . . . , and so on.

According to the existing BA protocol, the originator sequentially transmits a series of Media Access Control (MAC) Protocol Data Units (MPDUs) based on their assigned sequence numbers. Upon successful reception of an MPDU, the recipient decodes or equivalently decapsulates the received MPDU as MAC Service Data Unit (MSDU), and then delivers the decoded MSDU to the Logical Link Control (LLC) layer according to an in-order delivery scheme. However, this conventional BA approach may cause a head-of-line (HOL) blocking issue when a preceding MPDU in the reorder buffer is missing and thus forms a hole. In such cases, even if subsequent MPDUs are correctly received, they are unable to be delivered to the LLC layer and just get stuck in the reorder buffer. This results in a delay, as the entire process of data frame transmission is impeded by the missing MPDU forming a hole, thereby leading to the overall latency in communication.

For example, as shown in FIG. 5, data frames labeled as SN=1 to x+4 (not shown) have been successfully received and, conforming to the in-order delivery requirements, have been delivered to the LLC layer. However, data frame SN=x+5 is not successfully received. As a result, even if data frame SN=x+6 is subsequently received correctly, it remains in the reorder buffer owing to the “hole” created by the missing data frame SN=x+5 and the in-order delivery restrictions, thus preventing its delivery to the LLC layer. This is true for all the following data frames, which means that if SN=x+5 is not successfully received, all the following data frames SN=x+6, SN=x+7, SN=x+8, . . . , will be “blocked”.

After the block of data frames being transmitted, the BA frame will be transmitted by the recipient in response to the BAR to report the unsuccessful reception of data frame SN=x+5, allowing for its retransmission. As shown in FIG. 5, after receiving the BA frame, the originator will retransmit data frame SN=x+5. Until the recipient successfully receives both data frames SN=x+5 and SN=x+6 (which means that the hole due to SN=x+5 is resolved), the two data frames SN=x+5 and SN=x+6 can then be delivered to the upper LLC layer in accordance with the in-order delivery scheme.

Although the above description introduces the HOL blocking issue with reference to the Immediate BA mechanism, those skilled in the art would appreciate that at least the following issues exist in the traditional BA mechanisms, including but not limited to the immediate BA mechanism, the delayed BA mechanism, the HT-immediate BA mechanism, and the HT-delayed BA mechanism. The HOL blocking issue causes a gap between the timings of receiving the MPDUs and transferring these MPDUs to the LLC layer in the format of MSDUs, so the delivery of MSDUs according to the in-order delivery scheme is not performed in a timely manner. In addition, these incomplete MSDUs forming holes in the reorder buffer can only be retransmitted after the BA frame is received by the originator.

In the 802.11be standard, the Multi-Link Operation (MLO) technology is introduced, in which a single device, namely a Multi-Link (ML) device (MLD), implements a ML logical entity made of a plurality of stations. The stations can use 802.11 mechanisms to communicate with stations of another MLD over respective communication links, thereby establishing a multilink communication session to exchange data units (e.g., MPDUs). Therefore, one MLD can transmit messages over multiple links simultaneously to improve throughput.

Herein, “multilink device”, “ML device” (MLD), “multilink logical entity”, “ML logical entity” (MLE), “multilink set” and “ML set” may be used interchangeably.

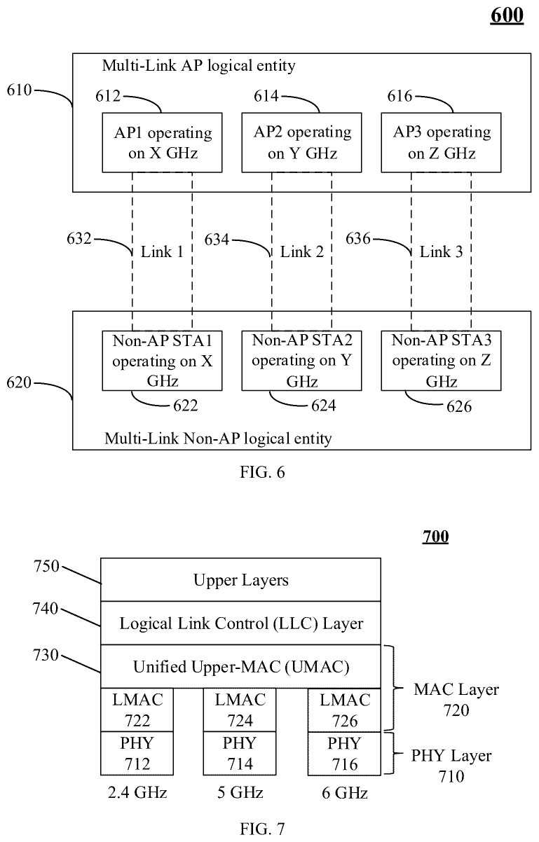

FIG. 6 illustrates an exemplary multi-link communication arrangement 600 in accordance with an embodiment of the present disclosure. As shown in FIG. 6, a multi-link AP logical entity 610, e.g., an AP MLD, may include a plurality of affiliated AP STAs, e.g., including an AP STA 612, an AP STA 614, and an AP STA 616. Furthermore, as shown in FIG. 6, a multi-link non-AP logical entity 620, e.g., a non-AP MLD, may include a plurality of affiliated non-AP STAs, e.g., including a non-AP STA 622, a non-AP STA 624, and a non-AP STA 626. The multi-link AP logical entity 610 and the multi-link non-AP logical entity 620 may be configured to form, setup and/or communicate over a plurality of communication channels or links, for example, including a link 632 (shown as link 1) between STA 612 and STA 622, a link 634 (shown as link 2) between STA 614 and STA 624, and/or a link 636 (shown as link 3) between STA 616 and STA 626. The terminology “link” is used to better align with the IEEE 802.11 standards. The AP STAs 612, 614, 616 and the non-AP STAs 622, 624, 626 operate in accordance with one or more of the IEEE 802.11 standards and other wireless communication standards.

The AP STAs 612, 614, 616 (and thus the corresponding non-AP STAs 622, 624, 626) may operate in frequency bands (shown as X, Y, Z) that are different one from the other as shown in the exemplary embodiment of FIG. 6. For instance, X=2.4 GHz, Y=5 GHz, and Z=6 GHz. Alternatively, two or more of the stations may use the same frequency band; for instance, y=z=6 GHz.

Although FIG. 6 shows an AP MLD and a non-AP MLD establishing a ML communication session, two non-AP MLDs may also establish such a ML communication session. Likewise, although MLDs made of three stations are shown in FIG. 6, MLDs with another number of affiliated stations may be contemplated with the same teachings. In addition, MLDs may have different numbers of affiliated stations.

FIG. 7 illustrates an exemplary multi-link reference model 700 for a ML device in accordance with an embodiment of the present disclosure. The ML device illustrated in FIG. 7 may be an AP ML device or a non-AP ML device, and may be an originator ML device (i.e., device transmitting data) or a recipient ML device (i.e., device receiving data from the originator ML device).

As shown in FIG. 7, the ML device comprises a PHY layer 710, a MAC layer 720, a logical Link Control (LLC) layer 740 and upper layers 750. Upper layers may include applications that generate traffic data for transmission by the MAC and PHY layers over the multiple links or that use traffic data received by the MAC and PHY layers over the multiple links.

The PHY layer 710 comprises multiple PHY blocks 712, 714, 716 dedicated for respective multiple links, for example, links 632, 634, 636 in FIG. 6. The MAC layer 720 also comprises multiple blocks 722, 724, 726 for respective multiple links, for example, links 632, 634, 636 in FIG. 6. The MAC layer 720 further comprises a Unified Upper MAC (UMAC) 730. UMAC 730 is responsible for link-agnostic MAC procedures such as fragmentation, sequence number assignments, MPDU encryption/decryption, duplication detection, dynamic link switching, block ack scoreboarding, etc. It offers a UMAC interface with the link-specific blocks 722, 724, 726 (forming lower MAC sublayers, therefore referred to as LMAC) and provides a UMAC Service Access Point (SAP) to the LLC layer 740 and the upper layers 750.

Although FIG. 7 shows three LMAC and PHY blocks, another number of blocks may be contemplated depending on the number of links the ML device can manage. As an example, LMAC block 722 may be associated with link 1 of FIG. 6 (e.g., via PHY block 712), LMAC layer 724 may be associated with link 2 of FIG. 6 (e.g., via PHY block 714), and LMAC layer 726 may be associated with link 3 of FIG. 6 (e.g., via PHY block 716). That is, each link 632/634/636 may have an associated LMAC block 722/724/726 that performs link-specific features, such as channel access.

In some embodiments of the present disclosure, similar as the description with reference to FIGS. 2-3, the BA session may be established between the originator MLD and the recipient MLD through the exchange of ADDBA request and response frames. The MLD with data to send using the block ack mechanism is referred to as the originator MLD, and the MLD that is the intended recipient of that data is referred to as the recipient MLD. To setup a block ack agreement between two MLDs, an originator MLD may send an ADDBA Request frame through an affiliated STA to the recipient MLD, on any enabled link, indicating the TID for which the block ack agreement is being set up. Upon receiving an ADDBA Request frame, the recipient MLD may respond through an affiliated STA, on any enabled link, with an ADDBA Response frame subject to the power states of the STAs operating on the link. The recipient MLD has the option of accepting or rejecting the request. If the recipient MLD accepts the request, then a block ack agreement is established between the originator MLD and the recipient MLD for the TID specified in the ADDBA frames. A single block ack agreement is negotiated between the two ML devices for a given traffic (i.e., TID) that may be transmitted over one or more links, meaning that it is negotiated at UMAC level regardless of the links to be used.

If an MLD has established a block ack agreement with another MLD, then QoS Data frames for the TID associated with the block ack agreement may be exchanged between the two MLDs on any link to which the TID is mapped. A STA affiliated with a recipient MLD may provide, to the STA affiliated with the originator MLD that is operating on the same link, the reception status for any MPDU, with ACK policy other than No Ack, that is received on the link on which the STA affiliated with the recipient MLD is operating on. A recipient MLD may maintain a single common receive reordering buffer for each tuple under a block ack agreement, independent of the number of links that are setup. The receive reordering buffer may be responsible for reordering MSDUs or A-MSDUs so that MSDUs or A-MSDUs are eventually passed up to the next MAC process in the order of received sequence number. It may also be responsible for identifying and discarding duplicate frames (i.e., frames that have the same sequence number as a currently buffered frame) that are part of this block ack agreement.

As mentioned above, in the 802.11be standard, QoS Data frames for the TID associated with the block ack agreement are exchanged between two MLDs on any link to which the TID is mapped, and thus the MLD BA mechanisms also require retransmission of the missing MPDUs or A-MPDUs until receiving BA frame, involving the HOL blocking issue. In order to mitigate the HOL blocking issue, the present disclosure proposes an enhancement for the current MLD BA mechanisms, which addresses the HOL blocking issue based on the originator ML device. To be specific, if the communication devices support MLO functionality, a transmit diversity approach is applied so that the originator ML device simultaneously transmits a block of data frames on the multiple links associated to the recipient ML device, respectively. Accordingly, at the recipient ML device, the data frames could be promptly delivered to upper layers higher than the LMAC layer.

In some embodiments of the present disclosure, an indication (for example, a field) indicating the adopted MLD BA scheme may be added into the ADDBA request and response frames. In alternative embodiments, the indication indicating the adopted MLD BA scheme may be not included in the ADDBA request frame or the ADDBA response frame, for example, the indication indicating the adopted MLD BA scheme may be transmitted after the ADDBA request frame or the ADDBA response frame. In some embodiments of the present disclosure, the indication indicating the adopted MLD BA scheme may be a HOL support indication, for example a HOL support field. In some embodiments of the present disclosure, the field indicating the adopted MLD BA scheme may include two bits, wherein “00” represents traditional MLD BA scheme, “01” represents in-order delivery diversity MLD BA scheme (i.e., transmitting duplicated sets of data frames in the same order on the multiple links), “10” represents out-of-order delivery diversity MLD BA scheme (i.e., transmitting duplicated sets of data frames in different orders on the multiple links), “11” is reserved. In some embodiments of the present disclosure, the traditional MLD BA scheme may refer to the BA scheme in the 802.11be standard, in which QoS Data frames for the TID associated with the block ack agreement are exchanged between two MLDs on any link to which the TID is mapped, rather than on multiple links.

In some embodiments of the present disclosure, the indication indicating the adopted MLD BA scheme may be an out-of-order (OOO) support indication (for example, OOO field with one bit), wherein “0” represents in-order delivery scheme and “1” represents out-of-order delivery scheme.

By means of the indication indicating the adopted MLD BA scheme, the originator MLD could transmit QoS Data frames for the TID associated with the block ack agreement according to the corresponding transmit diversity approach, and the recipient MLD could deliver the QoS Data frames to upper layers according to the corresponding delivery scheme.

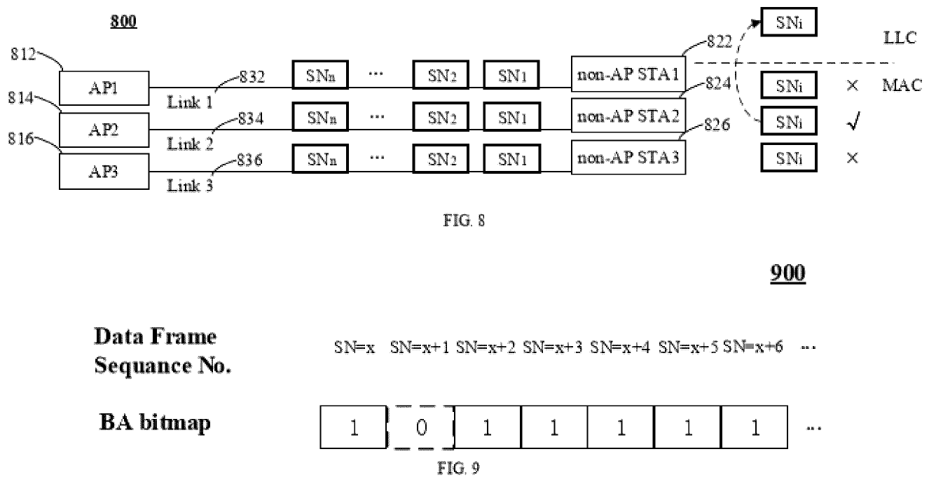

FIG. 8 shows an exemplary schematic diagram illustrating an enhanced MLD BA mechanism in accordance with an embodiment of the present disclosure.

As shown in FIG. 8, AP1-AP3 812, 814, 816 are affiliated with an AP MLD, which is an originator MLD, and non-AP STA1-STA3 822, 824, 826 are affiliated with a non-AP MLD, which is a recipient MLD. Furthermore, a link 832 (shown as Link 1) is established between AP1 812 and non-AP STA1 822, a link 834 (shown as Link 2) is established between AP2 814 and non-AP STA2 824, and a link 836 (shown as Link 3) is established between AP3 816 and non-AP STA3 826.

In response to the indication indicating that the diversity MLD BA scheme corresponds to in-order delivery, for example, the corresponding field with the value of “01”, the AP MLD may deliver a block of data frames (i.e., QoS Data frames for the TID associated with the block ack agreement) on each of the multiple links 832-836 in the same order of SN₁, SN₂, . . . , SNₙ. In other words, the AP MLD delivers duplicated sets of data frames on the multiple links 832-836 in the same order of SN₁, SN₂, . . . , SNₙ. Under normal circumstances, the non-AP MLD may receive three identical data frames with the same sequence number at the same sequence index of the received sequence of data frames. Under abnormal circumstances, if the i^{th} data frames transmitted on Link 1 and Link 3 are not correctly received, which may render the HOL blocking issue on Link 1 and Link 3, and if the i^{th} data frame transmitted on Link 2 is correctly received, the i^{th} data frame transmitted on Link 2 may be delivered from the MAC layer to the LLC layer of the non-AP MLD, refraining the issue that the subsequent data frames cannot be delivered to the LLC layer, and thus the HOL blocking issue can be resolved.

FIG. 9 shows an exemplary schematic diagram illustrating a BA bitmap 900 in the enhanced MLD BA mechanism in accordance with an embodiment of the present disclosure.

As shown in FIG. 9, in some embodiments of the present disclosure, multiple links (e.g., 832-836 in FIG. 8) share a single scoreboard, which may be a BA bitmap comprising bits associated with respective sequence number (from an agreed starting sequence number, SSN), a bit taking the 0-value if the data unit with the corresponding sequence number has not been correctly received over all of the multiple links at the time of building the bitmap or the 1-value if the data unit has been correctly received over any of the multiple links. For example, the data frame with the sequence number SN=x+1 shown in FIG. 9 has not been correctly received over any of the multiple links.

In some embodiments of the present disclosure, in response to receipt of a second data frame of the block of data frames over a first link of the multiple links subsequent to receipt of a third data frame over a second link of the multiple links, the second data frame may be discarded, wherein the third data frame has a sequence number larger than or equal to a sequence number of the second data frame. In other words, if a data frame (e.g., SN=x+2) has been correctly received over Link 1, the corresponding bit in the BA bitmap is set to 1, and if the same data frame (e.g., with the same sequence number SN=x+2) is correctly received over Link 2 or Link 3 later, the same data frame received later would be discarded.

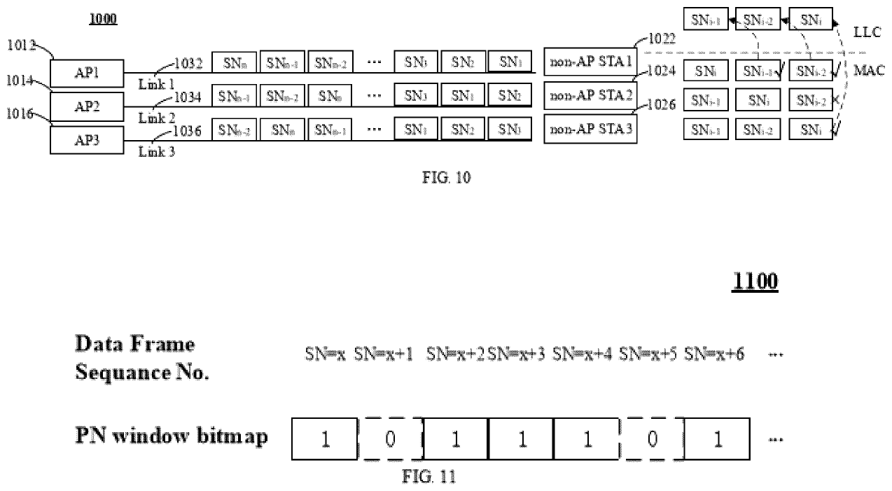

FIG. 10 shows an exemplary schematic diagram illustrating another enhanced MLD BA mechanism in accordance with an embodiment of the present disclosure. The MLO arrangement shown in FIG. 10 is similar as the MLO arrangement shown in FIG. 8, and the details are omitted.

As shown in FIG. 10, in response to the indication indicating that the diversity MLD BA scheme corresponds to out-of-order delivery, for example, the corresponding field with the value of “10”, the AP MLD may transmit a block of data frames (i.e., QoS Data frames for the TID associated with the block ack agreement) on the link 1032 (shown as Link 1) in the order of SN₁, SN₂, SN₃, . . . , SNₙ₋₂, SNₙ₋₁, SNₙ, on the link 1034 (shown as Link 2) in the order of SN₂, SN₁, SN₃, . . . , SNₙ, SNₙ₋₂, SNₙ₋₁, on the link 1036 (shown as Link 3) in the order of SN₃, SN₂, SN₁, . . . , SNₙ₋₁, SNₙ, SNₙ₋₂. That is, the plurality of data frames of the block are delivered on the multiple links 1032-1036 in different orders. Different from the embodiments shown in FIG. 8, the non-AP MLD should receive data frames according to different SN sequences, and thus will deliver the received data frames from the MAC layer to the LLC layer of the non-AP MLD in the manner of out-of-order.

As shown in FIG. 10, the AP MLD may transmit the data frame with the sequence number SNᵢ₋₂ on Link 1 and Link 2 and the data frame with the sequence number SNᵢ on Link 3 simultaneously. The non-AP MLD failed to receive the data frame SNᵢ₋₂ on Link 2 but received it on Link 1 and received the data frame SNᵢ on Link 3 simultaneously. The data frame SNᵢ₋₂ will be delivered to the LLC layer immediately after being received on Link 1, and thus the HOL blocking issue owing to failure of receiving the data frame SNᵢ₋₂ on Link 2 could be addressed. Moreover, the AP MLD may transmit on Link 1 the data frame SNᵢ₋₁ after the data frame SNᵢ₋₂, and the data frame SNᵢ₋₁ will be delivered to the LLC layer immediately after receiving on Link 1. It can be seen that the data frame with the larger sequence number SNᵢ is delivered to the LLC layer earlier than the data frame with the smaller sequences number SNᵢ₋₁, that is, delivering the data frames out of order.

FIG. 11 shows an exemplary schematic diagram illustrating a Packet Number (PN) window bitmap 1100 in the enhanced MLD BA mechanism in accordance with an embodiment of the present disclosure. Herein, the term “Packet Number” may be used interchangeable with “PN”, “Sequence Number”, “SN” or the like. In the out-of-order delivery scheme, for the received data frames, it is required to maintain (e.g., update) a Packet Number (PN) window bitmap, and multiple links (e.g., 1032-1036 in FIG. 10) share a single PN window bitmap. Each of a plurality of bits of the PN window bitmap associated with the plurality of data frames has a first value (e.g., “1”) for indicating that a corresponding data frame has been received and delivered to the LLC layer, or a second value (e.g., “0”) for indicating that the corresponding data frame has not been received and delivered to the second layer. Initially, each bit of the PN window bitmap has the second value (e.g., “0”).

In some embodiments of the present disclosure, in response to a current received data frame received via any of the multiple links having a PN whose corresponding bit in the PN window bitmap has the first value, the current received data frame is discarded, thereby discarding duplicated data frames. For example, as shown in FIG. 11, if the non-AP MLD receives the data frame with the sequence number SN=x+2, since the bit at PN window bitmap index “x+2” has the value of “1”, the received data frame SN=x+2 will be discarded.

In some embodiments of the present disclosure, in response to a current received data frame via any of the multiple links having a PN whose corresponding bit in the PN window bitmap has the second value, the current received data frame is delivered from the first layer to the second layer and the corresponding bit in the PN window bitmap is set to the first value. For example, as shown in FIG. 11, if the non-AP MLD receives the data frame with the sequence number SN=x+1, since the bit at PN window bitmap index “x+1” has the value of “0”, the received data frame SN=x+1 will be delivered to the LLC layer immediately and the bit at PN window bitmap index “x+1” will be set to “1”.

Those skilled in the art should be appreciated that although FIGS. 8-11 introduce the enhanced MLD BA mechanisms with the AP MLD as the originator MLD and the non-AP MLD as the recipient MLD, the originator MLD may be a ML non-AP entity and the recipient MLD may be a ML AP entity. Similarly, although MLDs made of three stations are shown in FIGS. 8 and 10, MLDs with another number of affiliated stations may be contemplated with the same teachings. In addition, MLDs may have different numbers of affiliated stations.

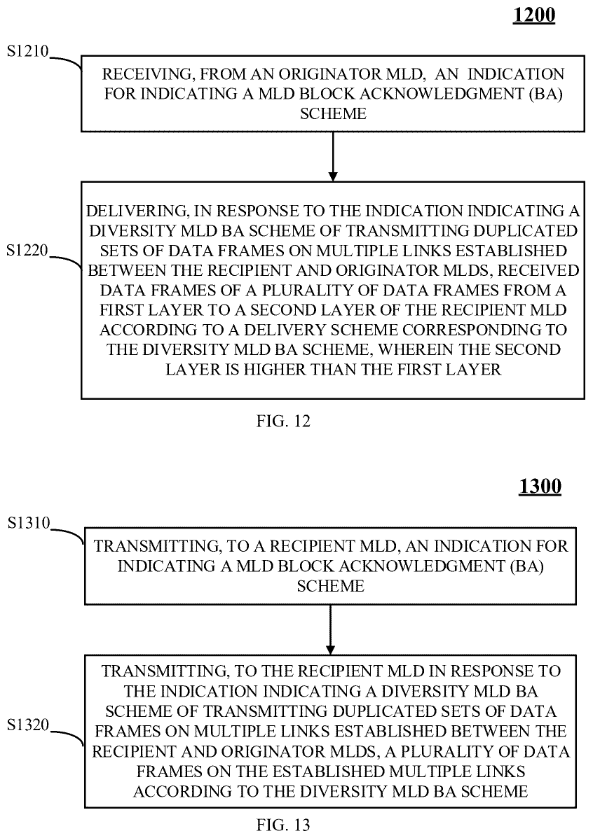

FIG. 12 shows a flowchart of a computer-implemented method 1200 for wireless communication implemented at a recipient MLD in accordance with an embodiment of the present disclosure.

The detailed description of method 1200 can refer to the content described in the above with respect to FIGS. 1-11. For example, the method 1200 can be executed in the architecture described with respect to FIGS. 1-11 and according to the interactions between the originator and recipient when transmitting data frames therebetween using the enhanced MLD BA mechanism as described with respect to FIGS. 1-11 (e.g., FIGS. 8-11). In addition, each step of method 1200 can be performed by one or more processing units, such as central processing unit (CPU) of the client device.

With reference to FIG. 12, method 1200 comprises steps S1210-S1220. At step S1210, the recipient MLD may receive, from an originator MLD, an indication for indicating a MLD Block Acknowledgment (BA) scheme. In accordance with embodiments of the present disclosure, the indication may indicate the MLD BA mechanism that the originator MLD applies.

At step S1220, the recipient MLD may deliver, in response to the indication indicating a diversity MLD BA scheme of transmitting duplicated sets of data frames on multiple links established between the recipient MLD and the originator MLD, received data frames of a plurality of data frames from a first layer to a second layer of the recipient MLD according to a delivery scheme corresponding to the diversity MLD BA scheme, wherein the second layer is higher than the first layer. In accordance with some embodiments, the recipient MLD may receive, from the originator MLD, a request frame for establishing a BA session for the plurality of data frames, and the request frame may include the indication.

In accordance with some embodiments, the recipient MLD may transmit to the originator MLD in response to the request frame a response frame for establishing the BA session, the response frame including the indication. In accordance with some embodiments, the indication may be not included in the request frame or the response frame, for example, the indication may be transmitted after the request frame or the response frame.

In accordance with some embodiments, in response to the indication indicating that the diversity MLD BA scheme corresponds to in-order delivery, the recipient MLD may deliver the received data frames that are transmitted in the same order via the established multiple links from the first layer to the second layer in order.

In accordance with some embodiments, in response to failure of receiving a first data frame of the plurality of data frames via a first link of the established multiple links and success of receiving the first data frame via a second link of the established multiple links, the recipient MLD may deliver the first data frame received via the second link to the second layer.

In accordance with some embodiments, in response to receipt of a second data frame of the plurality of data frames via a first link of the established multiple links subsequent to receipt of a third data frame via a second link of the established multiple links, the recipient MLD may discard the second data frame, wherein the third data frame has a Packet Number (PN) larger than or equal to a PN of the second data frame.

In accordance with some embodiments, in response to the indication indicating that the diversity MLD BA scheme corresponds to out-of-order delivery, the recipient MLD may deliver the received data frames that transmitted in different orders via thee established multiple links from the first layer to the second layer out of order.

In accordance with some embodiments, for the received data frames, the recipient MLD may maintain (e.g., update) a Packet Number (PN) window bitmap, wherein each of a plurality of bits of the PN window bitmap associated with the plurality of data frames has a first value for indicating that a corresponding data frame has been received and delivered to the second layer, or a second value for indicating that the corresponding data frame has not been received and delivered to the second layer.

In accordance with some embodiments, in response to a current received data frame received via any of the established multiple links having a PN whose corresponding bit in the PN window bitmap has the first value, the recipient MLD may discard the current received data frame.

In accordance with some embodiments, in response to a current received data frame via any of the established multiple links having a PN whose corresponding bit in the PN window bitmap has the second value, the recipient MLD may deliver the current received data frame from the first layer to the second layer and the corresponding bit in the PN window bitmap may be set to the first value.

In accordance with some embodiments, the out-of-order delivery may comprise delivering a first data frame of the plurality of data frames from the first layer to the second layer prior to receipt of a second data frame of the plurality of data frames at the first layer, wherein the first data frame has a Packet Number (PN) larger than a PN of the second data frame.

In accordance with some embodiments, the originator MLD may be a Multi-Link (ML) Access Point (AP) entity and the recipient MLD may be a ML non-AP entity; or the originator MLD may be a ML non-AP entity and the recipient MLD may be a ML AP entity.

In accordance with some embodiments, the plurality of data frames correspond to a plurality of MAC Protocol Data Units (MPDUs).

In accordance with some embodiments, the plurality of MPDUs are aggregated into an Aggregate MPDU (A-MPDU).

FIG. 13 shows a flowchart of a computer-implemented method 1300 for wireless communication implemented at an originator MLD in accordance with an embodiment of the present disclosure.

The detailed description of method 1300 can refer to the content described in the above with respect to FIGS. 1-11. For example, the method 1300 can be executed in the architecture described with respect to FIGS. 1-11 and according to the interactions between the originator and recipient when transmitting data frames therebetween using the enhanced MLD BA mechanism as described with respect to FIGS. 1-11 (e.g., FIGS. 8-11). In addition, each step of method 1300 can be performed by one or more processing units, such as central processing unit (CPU) of the client device.

With reference to FIG. 13, method 1300 comprises steps S1310-S1320. At step S1310, the originator MLD may transmit, to a recipient MLD, an indication for indicating a MLD Block Acknowledgment (BA) scheme. In accordance with embodiments of the present disclosure, the indication may indicate the MLD BA mechanism that the originator MLD applies.

At step S1320, the originator MLD may transmit, to the recipient MLD in response to the indication indicating a diversity MLD BA scheme of transmitting duplicated sets of data frames on multiple links established between the recipient MLD and the originator MLD, a plurality of data frames on the established multiple links according to the diversity MLD BA scheme. In accordance with some embodiments, the originator MLD may transmit, to the recipient MLD, a request frame for establishing a BA session for the plurality of data frames, and the request frame may include the indication.

In accordance with some embodiments, the originator MLD may receive, from the recipient MLD, a response frame for establishing the BA session, the response frame including the indication. In accordance with some embodiments, the indication may be not included in the request frame or the response frame, for example, the indication may be transmitted after the request frame or the response frame.

In accordance with some embodiments, in response to the indication indicating that the diversity MLD BA scheme corresponds to in-order delivery, the originator MLD may deliver the plurality of data frames in the same order via the established multiple links.

In accordance with some embodiments, in response to the indication indicating that the diversity MLD BA scheme corresponds to out-of-order delivery, the originator MLD may deliver the plurality of data frames in different orders via the established multiple links.

In accordance with some embodiments, the originator MLD may be a Multi-Link (ML) Access Point (AP) entity and the recipient MLD may be a ML non-AP entity; or the originator MLD may be a ML non-AP entity and the recipient MLD may be a ML AP entity.

In accordance with some embodiments, the plurality of data frames correspond to a plurality of MAC Protocol Data Units (MPDUs).

In accordance with some embodiments, the plurality of MPDUs are aggregated into an Aggregate MPDU (A-MPDU).

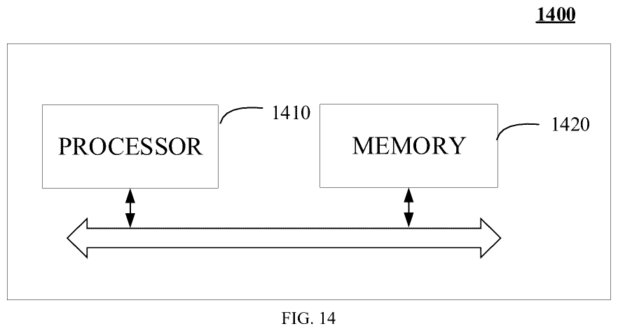

FIG. 14 is an exemplary block diagram illustrating a computing device in accordance with some embodiments of the present disclosure.

It should be noted that the computing device depicted in FIG. 14 can correspond to one or more of the originator MLD, the recipient MLD, the wireless communication device and the peer wireless communication device as described in FIGS. 1-13 and can be used to perform the actions involved in the MLD BA mechanism, for example, the method 1200-1300 as described above.

As shown in FIG. 14, the computing device 1400 can comprise processor 1410 and memory 1420. The processor 1410 is communicatively coupled with the memory and configured to perform the methods discussed above.

Examples of the processor 1410 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor 1410 can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 1420.

The memory 1420 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory 1420 may reside in the processor 1410, external to the processor 1410, or distributed across multiple entities including the processor 1410. The memory 1420 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

In addition, according to another embodiment of the present disclosure, a computer program product for wireless communication is disclosed. As an example, the computer program product comprises a non-transitory computer readable storage medium having program instructions embodied therewith, and the program instructions are executable by a processor. When executed, the program instructions cause the processor to perform one or more of the above described procedures, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Reference to an element in the singular is not intended to mean “one and only one” unless specifically so stated, but rather “one or more.” Similarly, reference to an element in the plural is not intended to mean “more than one” unless specifically so stated or being contradictory with the description elsewhere, but rather “one or more.” Terms such as “if,” “when,” and “while” should be interpreted to mean “under the condition that” rather than implying an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

It should be noted that the flowcharts and block diagrams in the attached drawings illustrate the possible architectures, functions and operations of the methods and apparatuses according to various embodiments of the present application. In this regard, each block in the flowchart or block diagram may represent a module, a program segment, or a part of code, which contains at least one executable instruction for implementing a specified logical function. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or by a combination of dedicated hardware and computer instructions

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of and is not intended to convey an indication of a preferred or ideal embodiment. “Such as” is not used in a restrictive sense, but for explanatory purposes.

It should be noted that the above-mentioned examples illustrate rather than limit the invention, and that those skilled in the art will be able to design many alternative embodiments without departing from the scope of the appended claims. Any reference signs in the claims shall not be construed so as to limit their scope.

What is claimed is:

1. A recipient Multi-Link Device (MLD), comprising:
one or more processors;
a memory coupled to at least one of the processors; and
a set of computer program instructions stored in the memory, which, when executed by at least one of the processors, perform actions of:
receiving, from an originator MLD, an indication for indicating a MLD Block Acknowledgment (BA) scheme; and
delivering, in response to the indication indicating a diversity MLD BA scheme of transmitting duplicated sets of data frames on multiple links established between the recipient MLD and the originator MLD, received data frames of a plurality of data frames from a first layer to a second layer of the recipient MLD according to a delivery scheme corresponding to the diversity MLD BA scheme, wherein the second layer is higher than the first layer.

2. The recipient MLD of claim 1, wherein the indication is included in a request frame for establishing a BA session for the plurality of data frames.

3. The recipient MLD of claim 2, wherein the set of computer program instructions stored in the memory, which, when executed by at least one of the processors, further perform actions of:
transmitting, to the originator MLD in response to the request frame, a response frame for establishing the BA session, the response frame including the indication.

4. The recipient MLD of claim 1, wherein the set of computer program instructions stored in the memory, which, when executed by at least one of the processors, further perform actions of:
in response to the indication indicating that the diversity MLD BA scheme corresponds to in-order delivery, delivering the received data frames that are transmitted in the same order via the established multiple links from the first layer to the second layer in order.

5. The recipient MLD of claim 4, wherein in response to failure of receiving a first data frame of the plurality of data frames via a first link of the established multiple links and success of receiving the first data frame via a second link of the established multiple links, the first data frame received via the second link is delivered to the second layer.

6. The recipient MLD of claim 4, wherein in response to receipt of a second data frame of the plurality of data frames via a first link of the established multiple links subsequent to receipt of a third data frame via a second link of the established multiple links, the second data frame is discarded, wherein the third data frame has a Packet Number (PN) larger than or equal to a PN of the second data frame.

7. The recipient MLD of claim 1, wherein the set of computer program instructions stored in the memory, which, when executed by at least one of the processors, further perform actions of:
in response to the indication indicating that the diversity MLD BA scheme corresponds to out-of-order delivery, delivering the received data frames that transmitted in different orders via the established multiple links from the first layer to the second layer out of order.

8. The recipient MLD of claim 7, wherein a Packet Number (PN) window bitmap is maintained for the received data frames, and wherein each of a plurality of bits of the PN window bitmap associated with the plurality of data frames has a first value for indicating that a corresponding data frame has been received and delivered to the second layer, or a second value for indicating that the corresponding data frame has not been received and delivered to the second layer.

9. The recipient MLD of claim 8, wherein in response to a current received data frame received via any of the established multiple links having a PN whose corresponding bit in the PN window bitmap has the first value, the current received data frame is discarded.

10. The recipient MLD of claim 8, wherein in response to a current received data frame received via any of the established multiple links having a PN whose corresponding bit in the PN window bitmap has the second value, the current received data frame is delivered from the first layer to the second layer and the corresponding bit in the PN window bitmap is set to the first value.

11. The recipient MLD of claim 7, wherein the out-of-order delivery comprises delivering a first data frame of the plurality of data frames from the first layer to the second layer prior to receipt of a second data frame of the plurality of data frames at the first layer, wherein the first data frame has a Packet Number (PN) larger than a PN of the second data frame.

12. The recipient MLD of claim 1, wherein the originator MLD is a Multi-Link (ML) Access Point (AP) entity and the recipient MLD is a ML non-AP entity; or the originator MLD is a ML non-AP entity and the recipient MLD is a ML AP entity.

13. An originator Multi-Link Device (MLD), comprising:
one or more processors;
a memory coupled to at least one of the processors; and
a set of computer program instructions stored in the memory, which, when executed by at least one of the processors, perform actions of:
transmitting, to a recipient MLD, an indication for indicating a MLD Block Acknowledgment (BA) scheme; and
transmitting, to the recipient MLD in response to the indicating a diversity MLD BA scheme of transmitting duplicated sets of data frames on multiple links established between the recipient MLD and the originator MLD, a plurality of data frames on the established multiple links according to the diversity MLD BA scheme.

14. The originator MLD of claim 13, wherein the indication is included in a request frame for establishing a BA session for the plurality of data frames.

15. The originator MLD of claim 14, wherein the set of computer program instructions stored in the memory, which, when executed by at least one of the processors, further perform actions of:
receiving, from the recipient MLD, a response frame for establishing the BA session, the response frame including the indication.

16. The originator MLD of claim 15, wherein the set of computer program instructions stored in the memory, which, when executed by at least one of the processors, further perform actions of:
in response to the indication indicating that the diversity MLD BA scheme corresponds to in-order delivery, delivering the plurality of data frames in the same order via the established multiple links.

17. The originator MLD of claim 13, wherein the set of computer program instructions stored in the memory, which, when executed by at least one of the processors, further perform actions of:
in response to the indication indicating that the diversity MLD BA scheme corresponds to out-of-order delivery, delivering the plurality of data frames in different orders via the established multiple links.

18. The originator MLD of claim 13, wherein the originator MLD is a Multi-Link (ML) Access Point (AP) entity and the recipient MLD is a ML non-AP entity; or the originator MLD is a ML non-AP entity and the recipient MLD is a ML AP entity.

19. A method for wireless communication implemented at a recipient Multi-Link Device (MLD), comprising:
receiving, from an originator MLD, an indication for indicating a MLD Block Acknowledgment (BA) scheme; and
delivering, in response to the indication indicating a diversity MLD BA scheme of transmitting duplicated sets of data frames on multiple links established between the recipient MLD and the originator MLD, received data frames of a plurality of data frames from a first layer to a second layer of the recipient MLD according to a delivery scheme corresponding to the diversity MLD BA scheme, wherein the second layer is higher than the first layer.

20. A method for wireless communication implemented at an originator Multi-Link Device (MLD), comprising:
transmitting, to a recipient MLD, an indication for indicating a MLD Block Acknowledgment (BA) scheme; and
transmitting, to the recipient MLD in response to the HOL support indication indicating a diversity MLD BA scheme of transmitting duplicated sets of data frames on multiple links established between the recipient MLD and the originator MLD, a plurality of data frames on the established multiple links according to the diversity MLD BA scheme.
